(19) United States
(12) Patent Application Publication
(10) Pub. No.: US 2011/0236041 A1
(43) Pub. Date: Sep. 29, 2011

(54) IMAGE FORMING DEVICE

(75) Inventors: Kazuhiko KOWASE, Toyokawa-shi (JP); Shigeo Tomita, Toyokawa-shi (JP)

(73) Assignee: Konica Minolta Business Technologies, Inc., Tokyo (JP)

(21) Appl. No.: 13/070,237

(22) Filed: Mar. 23, 2011

(30) Foreign Application Priority Data
Mar. 26, 2010 (JP) 2010-71412

(51) Int. Cl. G03G 15/00

(52) U.S. Cl. 399/20

(57) ABSTRACT

An image forming device which can feed a recording paper sheet of a normal size from a paper sheet feed part by a paper sheet feed roller unit to a transport roller unit on a next stage; can form an image on the paper sheet by feeding the sheet from the transport roller unit to an image forming part; and have the paper sheet feed roller unit transport the paper sheet in feeding the paper sheet from the transport roller unit to the image forming part, the image forming device comprising a paper sheet transport path which leads the paper sheet from the paper sheet feed roller unit to the transport roller unit; a paper sheet detection sensor disposed downstream of the paper sheet feed roller unit but upstream of the transport roller unit, facing the paper sheet transport path; and a size error judgment part which is for detecting a recording paper sheet size error when a small size recording paper sheet is mixed in the recording paper sheets of the normal size.

### CROSS-REFERENCE TO RELATED APPLICATION

This invention is based on Japanese patent application No. 2010-71412 filed in Japan on Mar. 26, 2010, the entire content of which is hereby incorporated by reference.

### BACKGROUND OF THE INVENTION

1. Field of the Invention

The present invention relates to an image forming device such as a copying machine, a printer, a facsimile machine, or a multifunctional machine produced by combining two or more of these.

2. Description of Related Art

In general, there is a known image forming device so constituted as to feed a sheet-like recording medium having a size on which an image is to be formed such as a recording paper sheet and a sheet for overhead projector (hereinafter these may be collectively referred to as “recording paper sheet” or “paper sheet”) from a recording paper sheet feed part by a paper sheet feed roller unit to a transport roller unit on a next stage located downstream of the paper sheet feed roller unit in the direction of transport of the recording paper sheet, further feed the recording paper sheet from the transport roller unit on the next stage to an image forming part to form an image on the recording paper sheet, in feeding the recording paper sheet from the transport roller unit on the next stage to the image forming part, also have the paper sheet feed roller unit transport the recording paper sheet at the same time with the transport by the transport roller unit on the next stage in order to stabilize the transport of the paper sheet.

Herein, examples of the “transport roller unit on the next stage” include a roller unit such as a roller unit for determining the timing for delivering the recording paper sheet to the image forming part so that an image is formed on the recording paper sheet, which is referred to as timing roller unit or register roller unit, and a paper sheet transport roller unit positioned upstream of such a roller unit in the direction of transport of the sheet.

In either case, in an image forming device of this type, the size of a recording paper sheet on which an image is to be formed is, for example, specified in a paper sheet size specifying part on an operational panel of the image forming device, or detected and confirmed by a paper sheet size detection part (e.g., a part for detecting the size of the paper sheet by the position of a paper sheet alignment ruler in the recording paper sheet feed part) in the recording paper feed part.

Paper sheet feeding of the image forming device from the recording paper sheet feed part is performed on the premise that normal size recording paper sheets specified by the recording paper sheet size specifying part or detected by the recording paper sheet size detection part are accommodated in the recording paper sheet feed part. The paper sheet feeding from the recording paper sheet feed part is performed so as to, based on the length of the recording paper sheet of the normal size in the direction of transport and the normal paper sheet transport speed by the paper sheet feed roller unit, transport the recording paper sheets sheet by sheet and provide intervals which would cause no problem for paper sheet transport, the image formation speed in the image forming part and other operations, between the preceding paper sheet and the following paper sheet.

However, in the image forming device which, in feeding the recording paper sheet from the transport roller unit on the next stage to the image forming part, also has the paper sheet feed roller unit transport the recording paper sheet, when a recording paper sheet of a different paper sheet size, for example, a small size paper sheet having a length in the direction of transport of the paper sheet shorter than that of the normal size paper sheet is mixed in normal size recording paper sheets, in feeding the small size paper sheet, the paper sheet feed roller unit and the like (including a pickup roller for dispensing paper sheets sheet by sheet positioned in front of the paper sheet feed roller unit, if any) in the paper sheet feed part continue the feeding operation during a period of time required for completion of transport of the normal size paper sheet which is longer than the length of the small size paper sheet in the direction of transport. Therefore, the paper sheet feed roller unit and the like continue rotating even after the rear end of the small size recording paper sheet has passed the paper sheet feed roller unit, resulting in feeding of the next paper sheet, and thus a paper sheet interval cannot be obtained between the preceding paper sheet and the following paper sheet.

In addition, if a recording paper sheet of a different size is mixed in the normal size recording paper sheets, paper jams may occur, or jams may be erroneously detected where there is none.

In this manner, in the image forming device which, in feeding a recording paper sheet from the transport roller unit on the next stage to the image forming part, also has the paper sheet feed roller unit transport the recording paper sheet continuously, if a recording paper sheet of a different size is mixed in the normal size recording paper sheets, it may adversely affect the feeding and transporting of recording paper sheets.

Relevant techniques include Japanese Unexamined Patent Publication No. 2003-72987 (JP2003-72987A), which suggests a method for, when a recording paper sheet of a size larger than the normal size recording paper is mixed and when a jam in the paper sheet feeding part is detected for the second the recording paper sheet, not judging that there is a jam, but performing a feeding operation of the second recording paper sheet after a sensor provided near register roller unit detects the rear end of the first recording paper sheet.

The method described in Japanese Unexamined Patent Publication No. 2003-72987 is a technique applicable to a case in which the size of the paper sheets which are actually set at the paper sheet feed port of the paper sheet feed part is larger than the normal size of the recording paper sheet to be detected by a detection means at this paper sheet feed port, and when an recording paper sheet having a size smaller than that of the normal size recording paper sheet on which an image is yet to be formed, such a state cannot be grasped as a paper sheet size error.

In addition, when the length of the recording paper sheet in the direction of transport detected in the paper sheet feed port is a multiple of the length of the recording paper sheet actually set in the paper sheet feed port in the direction of transportation, their lengths may be the same in the width direction in some cases, whereby a paper size error may not be detected.

### SUMMARY OF THE INVENTION

An object of the present invention is to provide an image forming device which can feed a recording paper sheet of a normal size specified in a recording paper sheet size specifying part or detected by a recording paper sheet size detection part from a recording paper sheet feed part by a paper sheet feed roller unit to a transport roller unit on a next stage located downstream of the paper sheet feed roller unit in a direction of transport of the recording paper sheet; can form an image on the recording paper sheet by feeding the recording paper sheet from the transport roller unit to an image forming part; and have the paper sheet feed roller unit transport the recording paper sheet in feeding the recording paper sheet from the transport roller unit on the next stage to the image forming part, the image forming device being capable of detecting a paper sheet size error for a small size recording paper sheet having a length shorter than that of the recording paper sheet of the normal size in the direction of transport of the recording paper sheet when the small size recording paper sheet is mixed in the recording paper sheets of the normal size.

In order to achieve the above object, one aspect of the present invention is to provide

an image forming device which can feed a recording paper sheet of a normal size specified in a recording paper sheet size specifying part or detected by a recording paper sheet size detection part from a recording paper sheet feed part by a paper sheet feed roller unit to a transport roller unit on a next stage located downstream of the paper sheet feed roller unit in a direction of transport of the recording paper sheet; can form an image on the recording paper sheet by feeding the recording paper sheet from the transport roller unit to an image forming part; and have the paper sheet feed roller unit transport the recording paper sheet in feeding the recording paper sheet from the transport roller unit on the next stage to the image forming part,
the image forming device comprising a paper sheet transport path which leads the recording paper sheet from the paper sheet feed roller unit to the transport roller unit on the next stage;

a paper sheet detection sensor disposed downstream of the paper sheet feed roller unit in the direction of transport of the recording paper sheet but upstream of the transport roller unit on the next stage, facing the paper sheet transport path, the paper sheet detection sensor being capable of detecting the recording paper sheet fed from the paper sheet feed roller unit; and

a size error judgment part which is for detecting a recording paper sheet size error when a small size recording paper sheet is mixed in the recording paper sheets of the normal size, the small size recording paper sheet being possibly expected to be mixed in the recording paper sheets of the normal size in the recording paper sheet feed part and having a length in the direction of transport of the recording paper sheet shorter than that of the normal size recording paper sheet.

The foregoing and other objects, features, aspects and advantages of the present invention will become more apparent from the following detailed description of the preferred embodiments of the present invention when taken in conjunction with accompanying drawings.

### BRIEF DESCRIPTION OF THE DRAWINGS

FIG. 1 shows an example of the constitution of the image forming device according to the present invention.

FIG. 2 is a block diagram which shows a control circuit of the image forming device of FIG. 1.

FIG. 3 shows an example of a long curved transport path which leads from a paper sheet feed roller unit of a recording paper sheet feed part to a register roller unit, a curved transport path which is shorter than the long curved transport path, and a paper sheet detection sensor facing the curved transport paths.

FIG. 4 shows how the recording paper sheet moves from the long curved transport path to the short curved transport path when the recording paper sheet is a normal size recording paper sheet.

FIG. 5 shows an example of the state of the recording paper sheet in the recording paper sheet transport path when a paper sheet size error is detected by using a reflection type paper sheet detection sensor.

FIG. 6 is a flowchart which shows a paper sheet size error detecting operation by the reflection type paper sheet detection sensor in a size error judgment part.

FIG. 7 shows an example of the state of the recording paper sheet in the recording paper sheet transport path when a paper sheet size error is detected by using a transmission type paper sheet detection sensor.

FIG. 8 shows an example of the state of the recording paper sheet in the recording paper transport path when a paper size error is detected by using a distance sensor.

FIG. 9 is a flowchart which shows a paper size error detecting operation by the size error judgment part using the distance sensor.

FIG. 10 is a flowchart which shows another example of a paper size error detecting operation by the size error judgment part using the distance sensor.

FIG. 11 shows an example of the state of the recording paper sheet in the recording paper transport path when a paper size error is detected by using a dynamic detector.

FIG. 12 is a flowchart which shows a paper size error detecting operation by the size error judgment part using the dynamic detector.

FIG. 13 schematically shows the constitution of another example of the image forming device according to the present invention.

### DESCRIPTION OF THE PREFERRED EMBODIMENTS

Embodiments of the present invention will be described below.

The image forming devices of the embodiments of the present invention is an image forming device which

can feed a recording paper sheet of a normal size specified in a recording paper sheet size specifying part or detected by a recording paper sheet size detection part from a recording paper sheet feed part by a paper sheet feed roller unit to a transport roller unit on a next stage located downstream of the paper sheet feed roller unit in a direction of transport of the recording paper sheet; can form an image on the recording paper sheet by feeding the recording paper sheet from the transport roller unit to an image forming part; and have the paper sheet feed roller transport the recording paper sheet in feeding the recording paper sheet from the transport roller unit on the next stage to the image forming part.

The image forming device comprises a paper sheet transport path which leads the recording paper sheet from the paper sheet feed roller unit to the transport roller unit on the next stage,

a paper sheet detection sensor disposed downstream of the paper sheet feed roller unit in the direction of transport of the recording paper sheet but upstream of the transport roller unit on the next stage, facing the paper sheet transport path, the paper sheet detection sensor being capable of detecting the recording paper sheet fed from the paper sheet feed roller unit, and

a size error judgment part which is for detecting a recording paper size error when a small size recording paper sheet is mixed in the normal size recording paper sheets, the small size recording paper sheet being possibly expected to be mixed in the normal size recording paper sheets in the recording paper sheet feed part and having a length in the direction of transport of the recording paper sheet shorter than that of the normal size recording paper sheet.

What kind of small-sized recording paper sheets may be mixed in the normal size recording paper sheets in the recording paper sheet feed part can be, for example, empirically grasped in advance.

In this image forming device, the paper sheet transport path may comprise a long curved transport path along which the recording paper sheet travels when the recording paper sheet is transported to the transport roller unit on the next stage by the continuous operation of the paper sheet feed roller unit. In the case of this paper sheet transport path, by slowing down the paper sheet feed roller unit in a state that the recording paper sheet lies across the paper sheet feed roller unit and the transport roller unit on the next stage and the transport roller unit on the next stage is in operation, the recording paper sheet on the long curved transport path can move onto a shorter curved transport path.

The size error judgment part is so constituted that, in feeding a recording paper sheet from the recording paper sheet feed part, when the recording paper sheet is a recording paper sheet of the normal size and a time period from a point of time the normal size recording paper sheet is started to be fed by the paper sheet feed roller unit until a point of time a rear end of the normal size recording paper sheet completely passes the paper sheet detection sensor is T1, when the recording paper sheet is a small size recording paper sheet and a time period from a point of time the small size recording paper sheet is started to be fed by the paper sheet feed roller unit to a point of time a rear end of the small size recording paper sheet completely passes the paper sheet feed roller unit is T2, the size error judgment part temporarily slows down the paper sheet feed roller unit for a predetermined time period after the time T2 has elapsed from the time the recording paper sheet is started to be fed by the paper sheet feed roller unit but before the time T1 elapses; judges that there is a size error which means that a size of the recording paper sheet is not the normal size when the paper sheet detection sensor detects absence of the normal size recording paper sheet from the slowing down of the paper sheet feed roller unit for the predetermined time period; judges that there is no size error when the absence of the normal size recording paper sheet is not detected by the paper sheet detection sensor even if the paper sheet feed roller unit is slowed down for the predetermined time and resumes a normal driving of the paper sheet feed roller unit after the predetermined time period has elapsed.

In the image forming device described above, examples of the “transport roller unit on the next stage” include a roller unit such as a roller unit for determining a timing for delivering the recording paper sheet to the image forming part so that an image is formed on the recording paper sheet, which is also referred to as timing roller unit or register roller unit. Alternatively, it may be a paper sheet transport roller unit on the next stage positioned downstream of the paper sheet feed roller unit and positioned upstream of such a timing or register roller unit in the direction of transport of the sheet.

In addition, the “slowing down of the paper sheet feed roller unit” herein, include a case in which the paper sheet transport speed is lower than the paper sheet transport speed by the normal driving of the paper sheet feed roller unit, and a case where the paper sheet feed roller unit is stopped.

Examples of the small size recording paper sheets which are judged to have size error by the size error judgment part include recording paper sheets having a length in the direction of transport of the recording paper sheet 1/n (n is an integer) (e.g., half) the length of the normal size recording paper sheet in the direction of transportation thereof. The small size recording paper sheets are, for example, A4-sized recording paper sheets mixed in A3-sized recording paper sheets, which are normal size recording paper sheets transported in the portrait orientation, with the A4-sized recording paper sheets transported in the landscape orientation.

According to the image forming device mentioned above, the recording paper sheet travels to the transport roller unit on the next stage along the paper sheet transport path, and when it reaches the transport roller unit on the next stage, it travels along the paper sheet transport path by the operation (paper sheet transport operation) of the transport roller unit on the next stage and the normal paper sheet transport driving of the paper sheet feed roller unit.

When the recording paper sheet lies across both the paper sheet feed roller unit and the transport roller unit on the next stage, by stopping or slowing down (excluding stopping) the paper sheet feed roller unit, the recording paper sheet on the paper sheet transport path can move onto a shorter paper transport path. As mentioned above, if the long curved transport path is provided as the paper sheet transport path, by stopping or slowing down the paper sheet feed roller unit (excluding stopping) when the recording paper sheet lies across both the paper sheet feed roller unit and the transport roller unit on the next stage, the recording paper sheet can move from the long curved transport path onto the shorter curved transport path.

As above described, the size error judgment part is so constituted that in feeding a recording paper sheet from the recording paper sheet feed part, when the recording paper sheet is a normal size recording paper sheet and a time period from the time the normal size recording paper sheet is started to be fed by the paper sheet feed roller unit until the time a rear end of the normal size recording paper sheet completely passes the paper sheet detection sensor is T1, and when the recording paper sheet is a small size recording paper sheet and a time period from the time the small size recording paper sheet is started to be fed by the paper sheet feed roller unit to the time a rear end of the small size recording paper sheet completely passes the paper sheet feed roller unit is T2, the size error judgment part temporarily slows down the paper sheet feed roller unit for a predetermined time period after the time T2 has elapsed from the time the recording paper sheet is started to be fed by the paper sheet feed roller unit but before the time T1 elapses. Accordingly, when the size of the recording paper sheet actually fed is smaller than that of the normal size recording paper sheet, the size error judgment part prevents travel of the next (following) recording paper sheet by the normal drive of the paper sheet feed roller unit, and judges that there is a size error when the paper sheet detection sensor detects absence of the normal size recording paper sheet from the slowing down of the paper sheet feed roller unit for the predetermined time period. When the paper sheet detection sensor does not detect the absence of the normal size recording paper sheet even by the slowing down of the paper sheet feed roller unit for the predetermined time period, it is judged that there is no size error and the normal drive of the paper sheet feed roller unit is resumed after the predetermined slowing down time period has elapsed.

Hence, even when the user sets, for example, paper sheets with a wrong size in the recording paper sheet feed part, a paper sheet size error can be detected and wasted paper sheets can be reduced.

An example of the timing for starting to slow down the paper sheet feed roller unit for the predetermined time period is a time point when the time T2 is reached (time T2 has elapsed) from the start of feeding of the recording paper sheet by the paper sheet feed roller unit.

In addition, the above-mentioned “predetermined time period for slowing down the paper sheet feed roller unit” may be set to be such a time period that the presence of a small size recording paper sheet having a size different from that of the normal size recording paper sheet mixed in the normal size recording paper sheets can be detected, but from the standpoint of preventing damage of the recording paper sheet of the normal size, the time period can be set, for example, in feeding of the normal size recording paper sheet by the paper sheet feed roller unit, to be shorter than the time period required for the normal size recording paper sheet moves from the state that it is positioned on the long paper sheet transport path onto the shortest paper sheet transport path by transport of the recording paper sheet by the transport roller unit on the next stage.

Various types of paper sheet detection sensors can be employed as such, and the judgment method by the size error judgment part can be set depending on the paper sheet detection sensor. Examples of those sensors will be listed below:

(1) The paper sheet detction sensor is a reflection type sensor which can detect the recording paper sheet by receiving light reflected from the recording paper sheet on the paper sheet transport path, and when there is a time period that the reflection type sensor cannot detect the recording paper sheet in the predetermined time period for slowing down the paper sheet feed roller unit, the size error judgment part judges that there is a size error.

(2) The paper sheet detection sensor comprises a transmission type sensor body and an actuator being capable of fitting to and retreating from the sensor body, and the paper sheet detection sensor is a transmission type sensor which can detect the recording paper sheet when the actuator is lifted by the recording paper sheet on the paper sheet transport path to retreat from the sensor body, and when there is a time period that the transmission type sensor cannot detect the recording paper sheet in the predetermined time period for slowing down the paper sheet feed roller unit, the size error judgment part judges that there is a size error.

(3) The paper feeding sensor is a distance sensor disposed in such a position that the sensor can detect a distance to the recording paper sheet on the paper sheet transport path, and the size error judgment part judges that there is a size error when the distance detected by the distance sensor is greater than a predetermined distance even after the predetermined time period for slowing down the paper sheet feed roller unit has elapsed.

(4) The paper feeding sensor is a dynamic detector which can detect movement of the recording paper sheet on the paper sheet transport path in a position in vicinity of the paper sheet feed roller unit, the size error judgment part stops the paper sheet feed roller unit during the predetermined time period for slowing down the paper sheet feed roller unit, and judges that there is a size error when there is a time period that the dynamic detector cannot detect the movement of the recording paper sheet while the paper sheet feed roller unit is stopped.

Examples of the image forming device will be described below with reference to drawings.

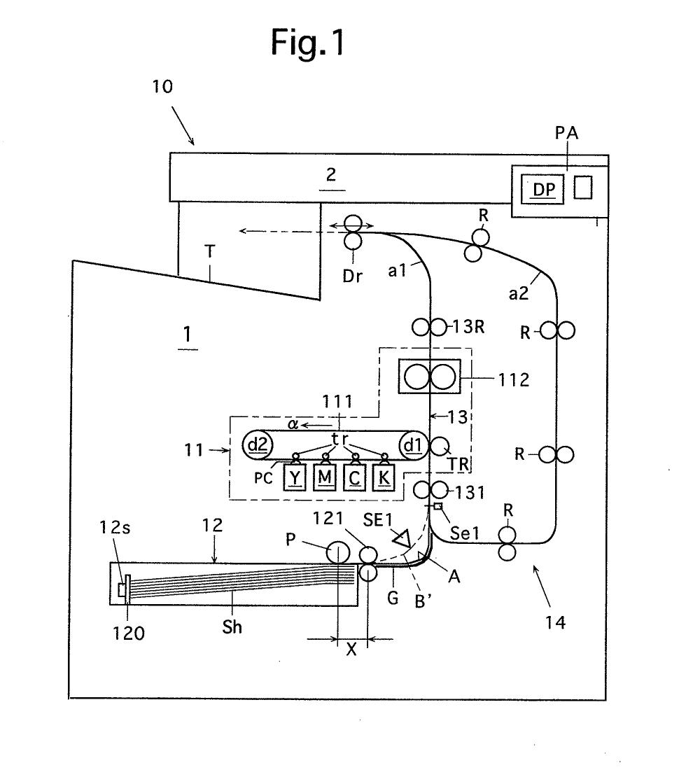

FIG. 1 shows the outline of the constitution of an example of the image forming device 1. The image forming device 10 in FIG. 1 is a multifunctional machine having the functions of a copying machine, printer, facsimile machine and other devices.

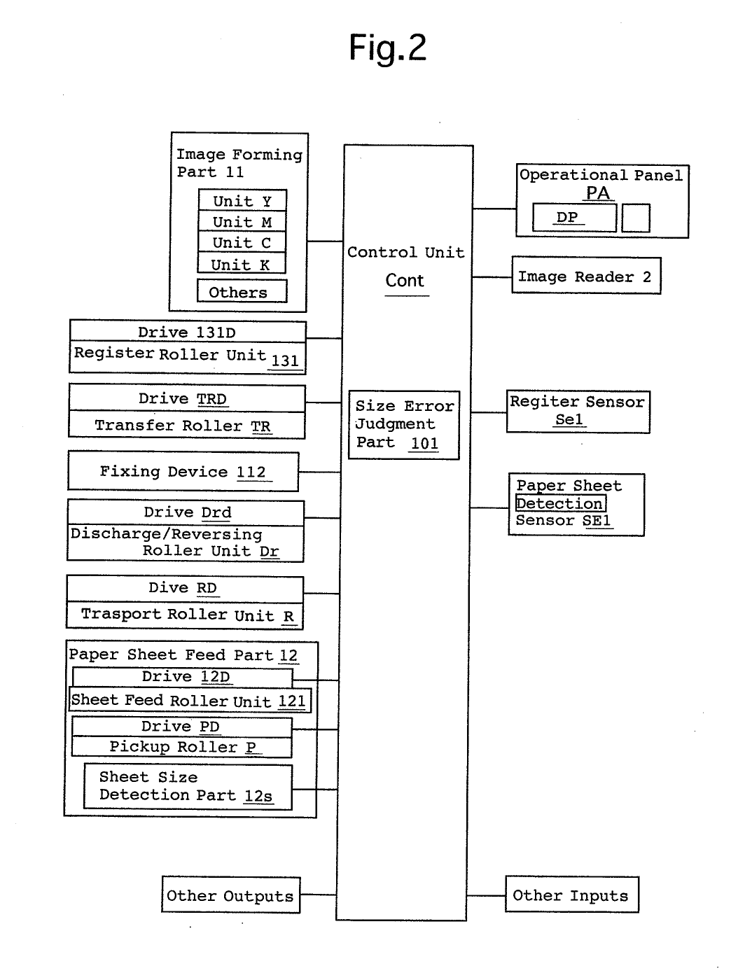

FIG. 2 is a block diagram which shows the outline of a control circuit of the image forming device 10 shown in FIG. 1.

The image forming device 10 shown in FIG. 1 comprises an image forming device body 1 and an image reader 2 mounted on the image forming device body 1, and a control unit Cont which controls the operation of the image forming device 10 (refer to FIG. 2). The operation of the components of the image forming device 10 is controlled by the instructions of the control unit Cont, as described later.

The image reader 2, which per se is one already known, reads an original image document and provides the read image information for document copying, facsimile transmission and other purposes.

The image forming device body 1 also comprises an image forming part 11, a recording paper sheet feed part 12 below the image forming part 11, an image forming path 13, a recording paper sheet transport path al leading from the image forming path 13, discharge reversing rollers Dr, and a reverse circulation transport path 14, among others.

The image forming part 11 comprises an intermediate transfer belt 111 which is rotationally driven by a belt drive (not illustrated), wound on a driving roller d1 and an opposing roller d2 and is capable of being rotationally driven in a counterclockwise direction a in the FIG. 1. A yellow image forming unit Y, a magenta image forming part M, a cyan image forming unit C and a black image forming unit K are disposed in the order stated along the belt 11 in the direction of travel of the belt.

Each of the image forming units which are assigned with color imaging can form an electrostatic latent image corresponding to the assigned color image by the electrophotographying system on a photosensitive member PC, form a toner image by developing the latent image with the assigned color toner, and primarily transfer this by a primary transfer roller tr to which a primary transfer bias is applied from a power source (not illustrated) onto the belt 111 by the instructions of the control unit Cont, based on, for example, image information from the image reader 2, image information transmitted from external computers (not illustrated), image information transmitted from external facsimile machines (not illustrated), or other image information.

In forming images by using the image forming units, a monochrome toner image can be formed by using one of the four image forming units, or a color image can be formed by using two or more of the image forming units. When two or more of the image forming units are used, the color toner images formed in those image forming units are primarily transferred onto the belt 111 at such a timing that they are stacked on the belt 111.

The image forming part 11 further comprises a secondary transfer roller TR opposing the intermediate transfer belt 111 on the downstream side of the black image forming unit K in the direction of rotation of the intermediate transfer belt 111 and a fixing device 112 disposed thereabove.

The image forming path 13 passes through a nipping portion between the transfer belt 111 and the secondary transfer roller TR, and the fixing device 112. The image forming path 13 is a transport path for secondarily transferring the primarily transferred toner image on the belt 111 onto a recording paper sheet fed from the recording paper sheet feed part 12 by the secondary transfer roller TR, and transporting the recording paper sheet so that the secondarily transferred toner image on the recording paper sheet is fixed by the fixing device 112. Discharge roller unit 13R comprising a discharge roller pair is disposed on the discharge side of the fixing device 112, and the paper sheet transport path al extends from the discharge roller unit 13R to the discharge reversing roller unit Dr comprising a discharge reversing roller pair. The roller unit Dr can be rotated to discharge a paper sheet or can be reversed in rotation direction for double-side image formation (reverse rotation) described later by a drive Drd (refer to FIG. 2) for the unit Dr.

Register roller unit (timing roller unit) 131 comprising a roller pair is disposed slightly upstream of the secondary transfer roller TR on the image forming path 13. The register roller unit 131 can be rotationally driven by its drive 131D (refer to FIG. 2). The register roller unit 131 is for temporarily stopping a recording paper sheet conveyed to the same, and delivering the recording paper sheet to a secondary transfer region at a timing that the toner image on the belt 111 arrives at the secondary transfer region. A register sensor Se1 is placed short of the register roller unit 131, and when a recording paper sheet is detected by this sensor, the recording paper sheet is temporarily stopped by the roller unit 131 in such a manner that it can be transported again.

As already described, the toner image which is primarily transferred onto the belt 111 is secondarily transferred onto a recording paper sheet transported along the image forming path 13 by the secondary transfer roller TR to which a secondary transfer bias is applied from a power source (not illustrated) and which is rotationally driven by a drive TRD (refer to FIG. 2). The toner image transferred on the recording paper sheet is fixed onto the recording paper sheet by the fixing device 112 under heat and pressure. The recording paper sheet is fed from the recording paper sheet feed part 12 below the image forming part 11 sheet by sheet. The recording paper sheet feed part 12 will be further described later.

In a single-side mode (single-side image formation mode) for forming an image on one side of a recording paper sheet and discharging the recording paper sheet, the recording paper sheet on which the secondarily transferred toner image is fixed by the fixing device 112 is transported to the paper sheet transport path al by the discharge roller unit 13R by the instructions of the control unit Cont, and travels to the discharge roller unit Dr along the paper sheet transport path a1, and is discharged onto a paper sheet discharging tray T by the discharge roller unit Dr.

In a double-side mode for forming images on both sides of the recording paper sheet (double-side image formation mode), a part of the recording paper sheet on which an image is formed on one side thereof is discharged onto the tray T by the discharge roller unit Dr by the instructions of the control unit Cont, and the discharge roller unit Dr is reversed before the rear end of the recording paper sheet passes the roller unit Dr. Accordingly, the recording paper sheet is loaded into the circulation transport path a2 of the reverse circulation transport path 14 with the aid of its rigidity against bending, and enters the image forming path 13 again by the paper sheet transport roller units R which are rotationally driven by a drive RD. The recording paper sheet is detected by the paper sheet detection sensor Se1 there, and is paused by the register roller unit 131. The recording paper sheet is then transported to the secondary transfer region by the register roller unit 131 at the timing the toner image for the other side face of the recording paper sheet on the belt 111 reaches the secondary transfer region, and is further passed to the fixing device 112. The recording paper sheet is then discharged onto the tray T.

In the recording paper sheet feed part 12, the position of a paper sheet alignment ruler 120 is set so that A3-sized recording paper sheets can be set in this example. In the sheet feed part 12, a ruler position detection sensor 12s, which is an example of a recording paper sheet size detection part, is provided. The ruler position detection sensor 12s detects the position of the ruler, whereby normal size recording paper sheets Sh to be set in the feed part 12, particularly the length of the paper sheet in the direction of transport (hereinafter also referred to as “FD length”.) is detected. The normal size of the recording paper sheet detected by the ruler position detection sensor 12s is input to the control unit Cont (refer to FIG. 2).

A pickup roller P and a paper sheet feed roller unit 121 comprising a feed roller pair are provided in the recording paper sheet feed part 12. The pickup roller P can be elevated, descended and driven to rotate by its drive PD (refer to FIG. 2). The pickup roller P is rotationally driven and lowered to draw a recording paper sheet from a group of the recording paper sheets Sh accommodated in the sheet feed part 12 sheet by sheet at the timing when the recording paper sheet is to be fed from the sheet feed part 12. The paper sheet feed roller unit 121 can be rotationally driven by a drive 12D (refer to FIG. 2), and receives a paper sheet dispensed by the roller P and feeds the same to the register roller unit 131 described later.

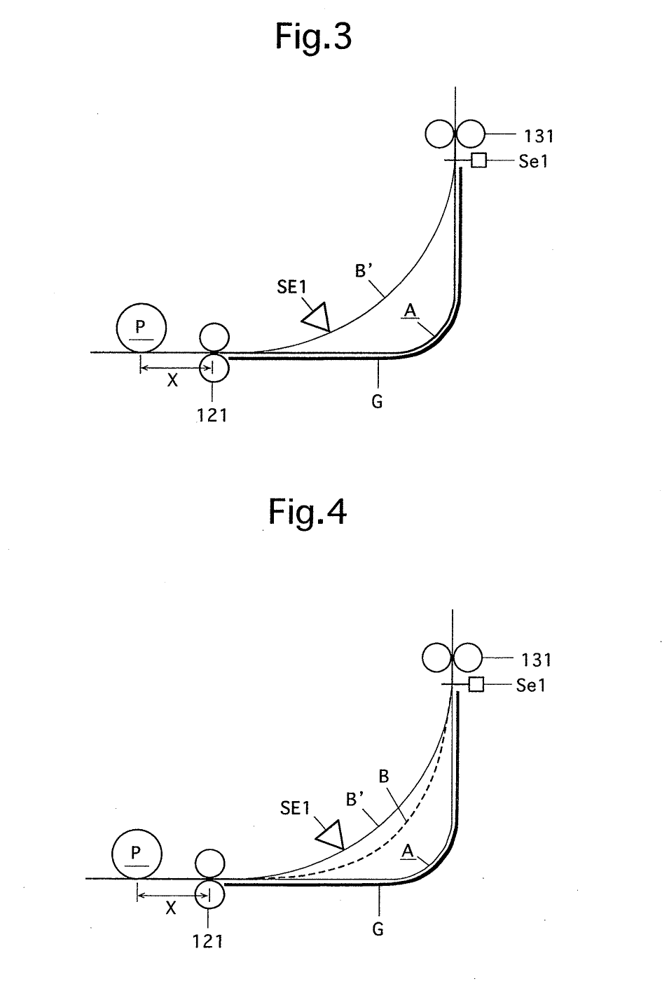

A paper guide G extends from the paper sheet feed roller unit 121 to the register roller unit 131. The recording paper sheet fed from the paper sheet feed roller unit 121 can travel along a long curved transport path A provided by the guide G to reach the register roller unit 131. This point will be further described with reference to FIGS. 3 and 4.

FIG. 3 shows the long curved transport path A from the paper sheet feed roller unit 121 of the recording paper sheet feed part 12 to the register roller unit 131, and a shorter curved transport path B′, and a paper sheet detection sensor SE1 opposing the curved transport paths. The paper sheet detection sensor SE1 comprises a light emitting portion and a light sensing portion which receives light emitted from the light emitting portion to an object to be detected and reflected from the same. The sensor SE1 is a reflection type sensor being capable of detecting an object to be detected by receiving the reflected light at the light sensing portion.

The long curved transport path A is a transport path along which the recording paper sheet travels when it is transferred to the register roller unit 131 by the continuous operation of the paper sheet feed roller unit 121. In a state that the recording paper sheet lies on the long curved transport path A and across the paper sheet feed roller unit 121 and the register roller unit 131, when the paper sheet feed roller unit 121 rotating at the normal sheet transport speed is stopped or slowed down (excluding stopping) with the register roller unit 131 in normal operation (rotated for normal paper sheet transport), as shown in FIG. 4, the recording paper sheet moves (shifts) onto the shorter curved transport path B′ or B (refer also to FIG. 4). The curved transport path B′ is the shortest curved transport path.

As shown in FIG. 2, the control circuit of the image forming device 10 comprises the control unit Cont which controls operations of the device 10, and the image forming part 11 and other driving parts of the operable components are operated by the instructions of the control unit Cont. The paper sheet detection informations detected by the register sensor Se1 and the paper sheet detection SE1 are input to the control unit Cont.

An operational panel PA for the operator (user) is also connected to the control unit Cont. On the operational panel PA, various Keys such as a key for specifying the size of the recording paper used for image formation, number keys for setting the number of sheets of image formation, keys for selecting single-side image formation mode or double-side image formation mode, and a display DP for indicating various information are provided.

In this embodiment, the recording paper sheet feed part 12 is for feeding recording paper sheets of a single size, but the recording paper sheet feed part may be provided with a plurality of sheet feed parts which can feed recording paper sheets of different sizes. In such a case, the operational panel PA may be so arranged as to allow selection of recording paper sheet of a desired size.

According to the image forming device 10 described above, in the recording paper sheet feed part 12, when small size recording paper sheets having a length (FD length) in the direction of transport of the sheet shorter than that of the normal size recording paper sheet are mixed in normal size recording paper sheets specified on the operational panel PA or detected by the sensor 12s of the recording paper sheet feed part, a paper sheet size error regarding the small size recording paper sheet can be detected. That is, in case of the small size recording paper sheet, it is transported to the register roller unit 131, and is withdrawn from the paper sheet feed roller unit 121. The size error can be therefore detected by the sensor SE1. A paper sheet size error judgment part 101 for that purpose is included in the control unit Cont. In the case of the example of the image forming device 10 of FIG. 1, only the paper sheet of a single size which can be accommodated in the recording paper sheet feed part 12 can be specified on the operational panel PA.

Herein, A4-sized paper sheet can be assumed as the small size paper sheet which is possibly expected to be mixed in the recording paper sheets of the normal size.

The A4-sized paper sheet is set so that the longitudinal direction of the A4-sized paper sheet is oriented in the width direction of the A3 size paper sheet feed part. That is, the A4-sized paper sheet is set in the A3 size paper sheet feed part in the landscape orientation. Although their lengths in the widthwise direction of the paper sheet feed part are the same, the FD length of the A4-sized paper sheet is 1/2 FD length of the normal size paper sheet. Herein, the case in which the paper sheet having 1/2 FD length of the normal size paper sheet is set has been described, but the small size paper sheet is not limited to this, and the paper sheets having a 1/3, 1/4 and like 1/n (n is an integer) FD length of the normal size paper sheet can be also assumed.

The paper sheet size error judgment part 101 will be further described.

The size error judgment part 101 performs recording paper sheet size error detection when a small size recording paper sheet which is empirically known to possibly be mixed in the normal size paper sheets in the recording paper feed part 12 and has a length in the direction of transport of the recording paper sheet shorter than that of the normal size recording paper is mixed in the normal size recording paper sheets.

In feeding of the recording paper sheet from the recording paper sheet feed part 12, when the recording paper sheet is a normal size recording paper sheet, the time period from the time the normal size recording paper sheet is started to be fed by the paper sheet feed roller unit 121 until the time a rear end of the normal size recording paper sheet completely passes the paper sheet detection sensor SE1 is referred to as T1. When the recording paper sheet is a small size recording paper sheet, the time period from the time the small size recording paper sheet is started to be fed by the paper sheet feed roller unit 121 to the time the rear end of the small size recording paper sheet completely passes the paper sheet feed roller unit 121 is referred to as T2.

The size error judgment part 101 starts to temporarily slow down the paper sheet feed roller unit 121 for a predetermined time after the time T2 has elapsed from the time the recording paper sheet is started to be fed by the paper sheet feed roller unit 121 but before the time T1 elapses. In this embodiment, the paper sheet feed roller unit 121 is started to be paused at a timing that the time T2 elapses from the time the paper sheet feed roller unit 121 starts to feed the recording paper sheet. This timing is set in the control unit Cont in advance.

By this pausing of the paper sheet feed roller unit 121 for the predetermined time, when the size of the recording paper sheet actually fed is smaller than that of the normal size recording paper sheet, travel of the next recording paper sheet by the normal drive of the paper sheet feed roller unit 121 is prevented. When the paper sheet detection sensor SE1 detects absence of the normal size recording paper sheet by the pausing the paper sheet feed roller unit 121 for the predetermined time, it is judged the recording paper sheet size is not the normal size, i.e., that there is a size error. When the paper sheet detection sensor SE1 does not detect the absence of the normal size recording paper sheet even by the slowing down of the paper sheet feed roller unit 121 for the predetermined time, it is judged that there is no size error and the normal drive of the paper sheet feed roller unit 121 is resumed after the predetermined slowing down time period has elapsed.

The predetermined time period for pausing the paper sheet feed roller unit 121 may be shorter than a period of time Ta required for the normal size recording paper sheet situated on the long curved transport path A across the paper sheet feed roller unit 121 and the register roller unit 131 in a state that no transport is provided by the paper sheet feed roller unit 121 to move onto the shortest curved transport path B′ by the operation of the register roller unit 131, but longer than a period of time Tb (<Ta), which will be described later. This pausing time is stored in the control unit Cont. Specifically, the period of time (pausing time) may be such that meets the following relationship:

Tb<Pausing time<Ta

The time period Ta is determined by dividing the distance between the curved transport paths A and B′ determined by calculation and (or) actual measurement by the speed of transport of the paper sheet by the register roller unit 131.

The time period Tb may be such a time period required for overlapping of the rear end of the preceding recording paper sheet and the front end of the following recording paper sheet to be cancelled by the pausing of the paper sheet feed roller unit 121 and continued driving by the register roller unit 131 and for obtaining such an interval provided between the preceding recording paper sheet and the following recording paper sheet that allows the paper sheet detection sensor to detect “no paper sheet”. In other words, the time period Tb may be the time period obtained by dividing the (overlapping length+interval) by the speed of transport of the paper sheet of the register roller unit 131. Such overlapping and interval can be determined by calculating in advance.

When the preceding recording paper sheet is shorter than the normal size paper sheet, overlapping of the rear end of the preceding recording paper sheet and the front end of the following recording paper sheet is generated by the pickup roller P which is operated so as to transport the normal size recording paper sheet, and touches the front end of the following recording paper sheet and dispenses the following paper sheet after the rear end of the preceding recording paper sheet has passed the pickup roller P.

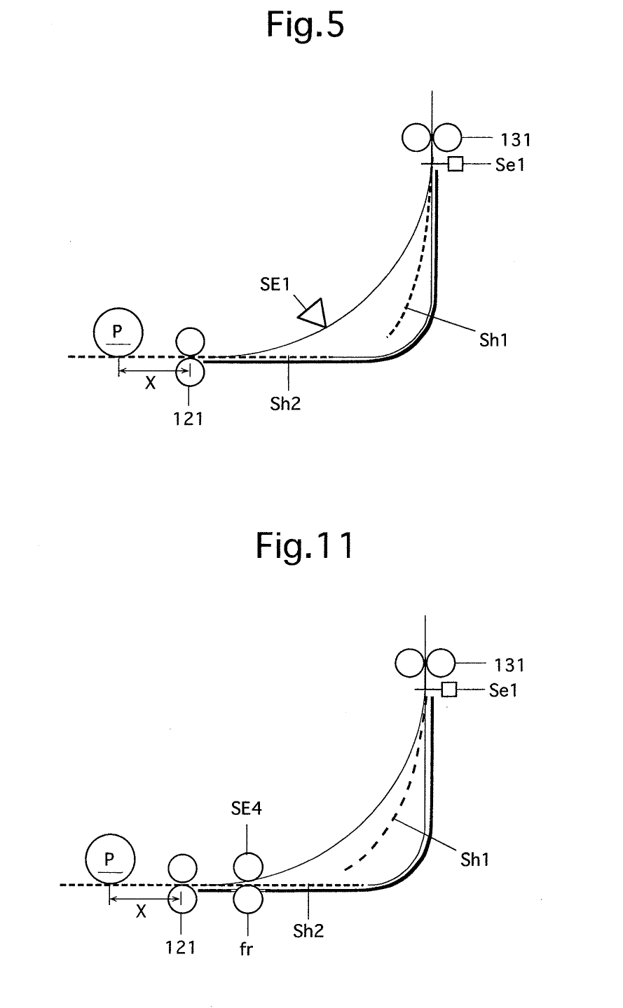

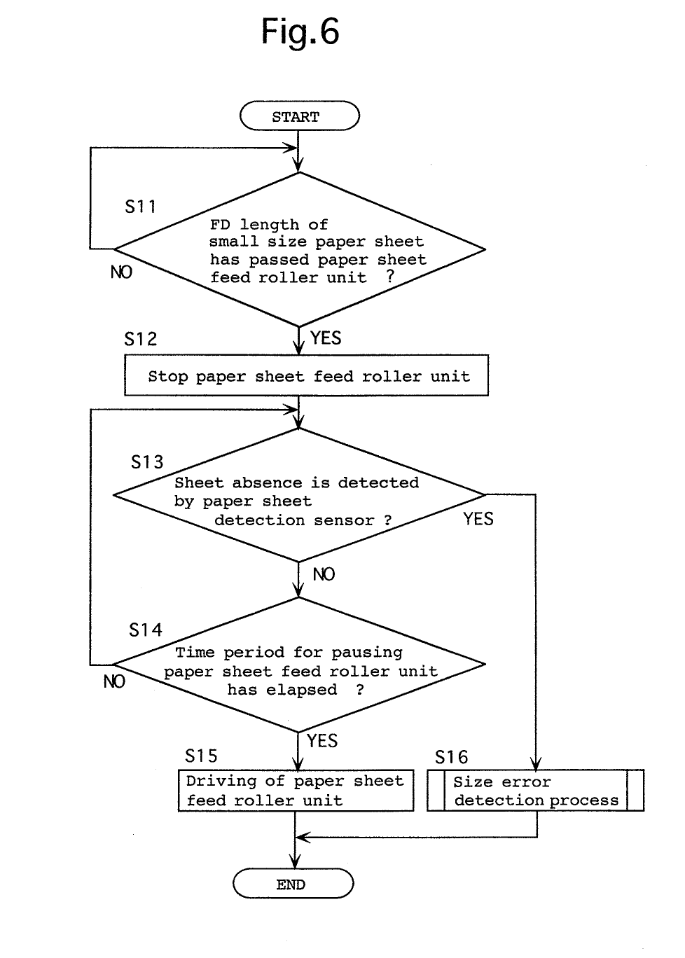

FIG. 5 shows an example of how a size error is detected using the reflection type paper sheet detection sensor SE1. Sh1 is a preceding paper sheet, while Sh2 is a following paper sheet. FIG. 5 shows that the paper sheet Sh1 is smaller than the normal size paper sheet, and therefore the sensor SE1 is detecting “no paper sheet” since the interval between the paper sheets Sh1 and Sh2 is large. The size error judgment part 101 of the control unit Cont operates as shown in the flowchart of FIG. 6.

That is, when the FD length (length in the direction of transport) of the small size recording paper sheet has passed the paper sheet feed roller unit 121, the paper sheet feed roller unit 121 is stopped. When the paper sheet detection sensor SE1 detects “no paper sheet” (in other words, when it cannot detect “paper sheet present”) (steps S11 to S13), the judgment part 101 judges that the length of the recording paper sheet is shorter than that of the normal size recording paper sheet and that the rear end of the recording paper sheet has already passed the detection position of the sensor SE1, and indicates an size error on the display DP of the operational panel PA as a size error detection process, and stops image formation (step S16). Printing on a paper sheet with a wrong size can be thus prevented.

In addition, when the paper sheet feed roller unit 121 is started to be stopped, even if the paper sheet detection sensor SE1 detects “paper sheet present” , “no paper sheet” is detected before the predetermined pausing period elapses, the size error judgment part 101 judges that the length of the recording paper sheet is shorter than that of the normal size recording paper sheet, and performs the size error detection process.

However, when the paper sheet detection sensor SE1 does not detect “no paper sheet” during the predetermined pausing period after the paper sheet feed roller unit is started to be paused, it judges that the paper size is a desired size (normal size), and resumes the driving of the paper sheet feed roller unit 121 (steps S13 to S15)

The paper sheet detection sensor SE1 may be a sensor of another type, in place of the reflection type.

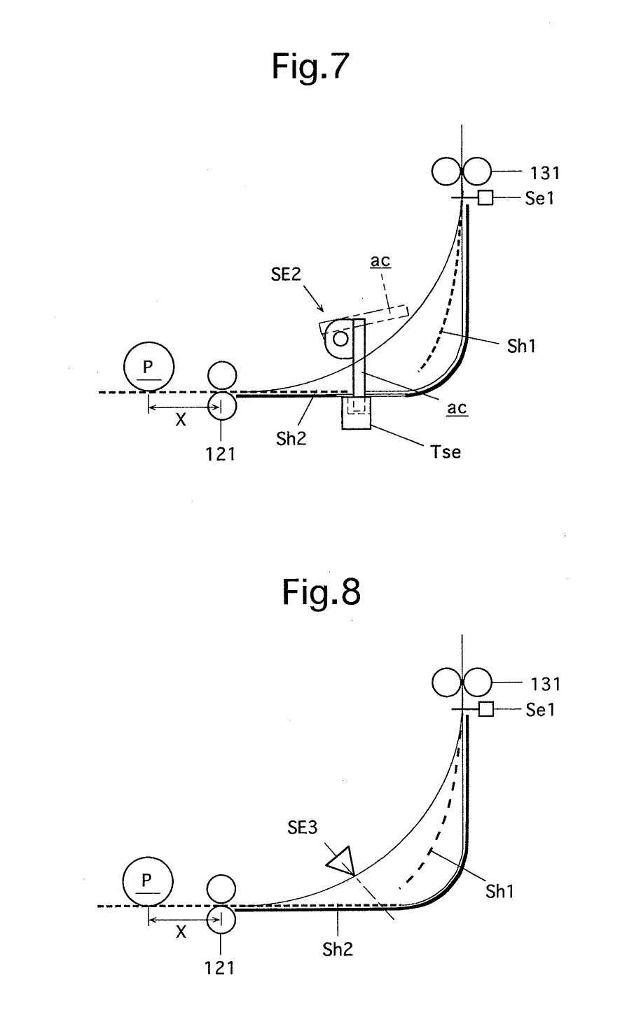

FIG. 7 is an example in which a transmission type sensor SE2 is employed as the paper sheet detection sensor.

The transmission type sensor SE2 comprises a transmission type sensor body Tse, and an actuator ac which can fit into and retreat from the transmission type sensor body Tse.

The sensor SE2 can detect the recording paper sheet when the actuator ac is lifted by the recording paper sheet on the curved transport path (e.g., lifted to the position shown by the chain line in FIG. 7) to be retreated from the sensor body Tse. When the recording paper sheet is shorter than the normal size recording paper sheet, and therefore an intervals is formed between the recording paper sheets, the actuator ac is swung downwards to be fitted (inserted) into the sensor body Tse, and the light which is passing in the sensor body is blocked, whereby a size error can be detected. The sensor SE2 can be used when the maximum interval between the long curved transport path A and the short curved transport path B′ is large (when the depth of the transport path A is great).

When the sensor SE2 is used, by the steps similar to those shown in the flowchart of FIG. 6, the size error judgment part 101 judges that the recording paper sheet size is not the normal size if there is a time period that the sensor SE2 cannot detect the recording paper sheet during the predetermined pausing time of the paper sheet feed roller unit 121.

In addition, as shown in FIG. 8, a distance sensor SE3 can be also employed as the paper sheet detection sensor. In FIG. 8, the interval between the preceding recording paper sheet Sh1 and the following recording paper sheet Sh2 is not very large, but the preceding paper sheet Sh1 is shorter than the normal size recording paper. Therefore, the preceding paper sheet Sh1 has lifted from the following paper sheet Sh2 and it has moved away from the detection position by the sensor SE3. The sensor SE3 therefore detects a distance to the recording paper sheet Sh2 in a distant position.

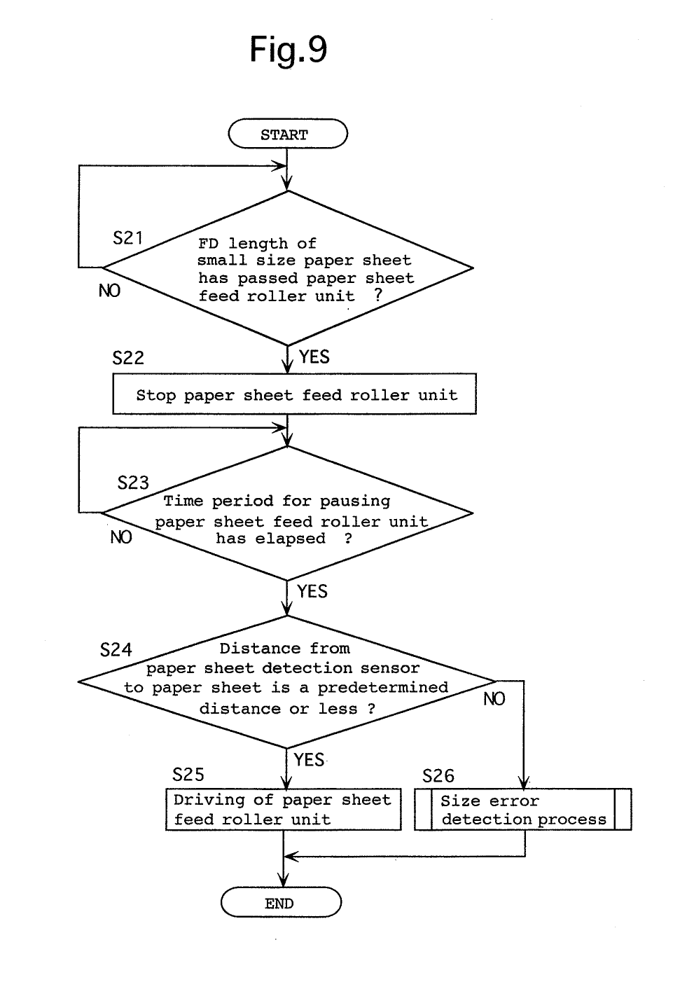

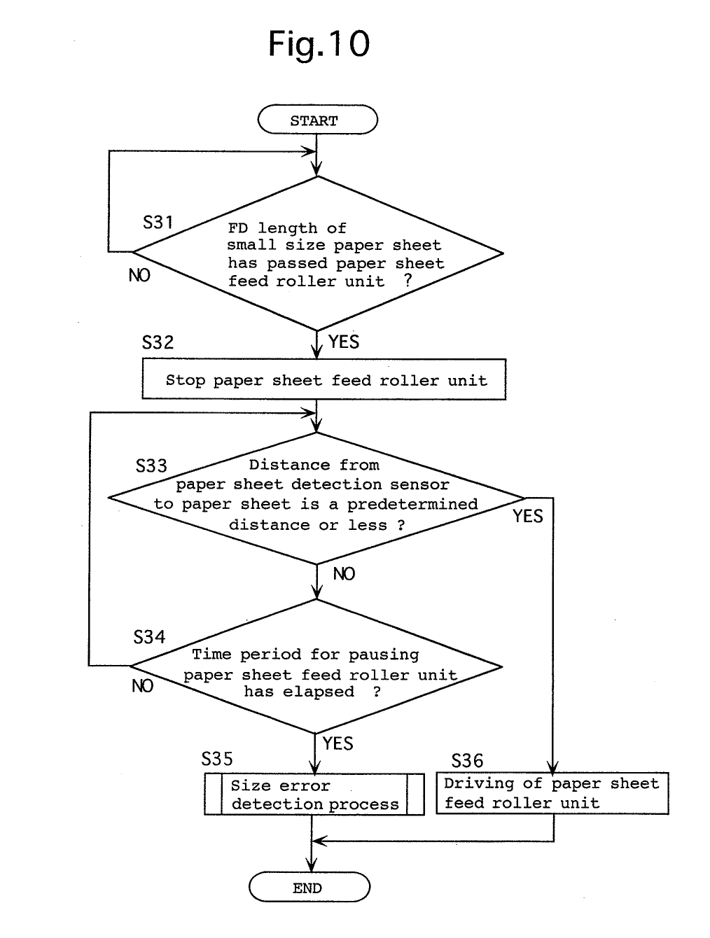

FIGS. 9 and 10 show an example of the operation of the size error judgment part 101 when the distance sensor SE3 is used.

In the example shown in FIG. 9, when the FD length of the small size recording paper sheet has passed the paper sheet feed roller unit 121, the paper sheet feed roller unit 121 is stopped; when a predetermined pausing period of the paper sheet feed roller unit 121 has elapsed, the distance from the distance sensor SE3 to the paper sheet is detected by the sensor; when the detection distance is greater than a predetermined distance which indicates “paper sheet present”, a size error detection process is performed (steps S21 to S24, S26); and when the detection distance is not greater than a predetermined distance which indicates “paper sheet present”, the driving of the paper sheet feed roller unit is resumed (step S25)

In the example shown in FIG. 10, when the FD length of the small size recording paper sheet has passed the paper sheet feed roller unit 121, the paper sheet feed roller unit 121 is stopped; the distance from the distance sensor SE3 to the paper sheet is detected by the distance sensors SE3; when the detection distance is not greater than a predetermined distance which indicates “paper sheet present”, the driving of the paper sheet feed roller unit is resumed (steps S31 to S34, S36), otherwise, it is judged that the length of the recording paper sheet is shorter than that of the normal size paper sheet, and a size error detection process is performed (step S35).

In any case, a possible range of the “predetermined distance” from the distance sensor SE3 which serves as a criterion for judging the presence or absence of a recording paper sheet is a range which is greater than the distance from the sensor SE3 to the recording paper sheet on the curved transport path B′, but smaller than the distance from the sensor SE3 to the recording paper sheet on the curved transport path A.

In addition, a dynamic detector can be also employed as a paper sheet detection sensor. In FIG. 11, an encoder SE4 which can detect contact movement of an object is employed as a dynamic detector. A follower roller Fr is disposed opposing the encoder SE4. The encoder SE4 is disposed in the vicinity of the paper sheet feed roller unit 121. When the preceding recording paper is a normal size paper sheet, it is pulled by the register roller unit 131 after the paper sheet feed roller unit 121 is paused. Therefore, the encoder SE4 detects the movement of the paper sheet, whereby the presence of the paper sheet can be detected. FIG. 11 shows an example in which the preceding paper sheet Sh1 is smaller than the normal size paper sheet, and the following paper sheet Sh2 cannot be pulled by the register roller unit 131, and therefore the encoder SE4 cannot detect the movement of the paper sheet, whereby a size error is detected.

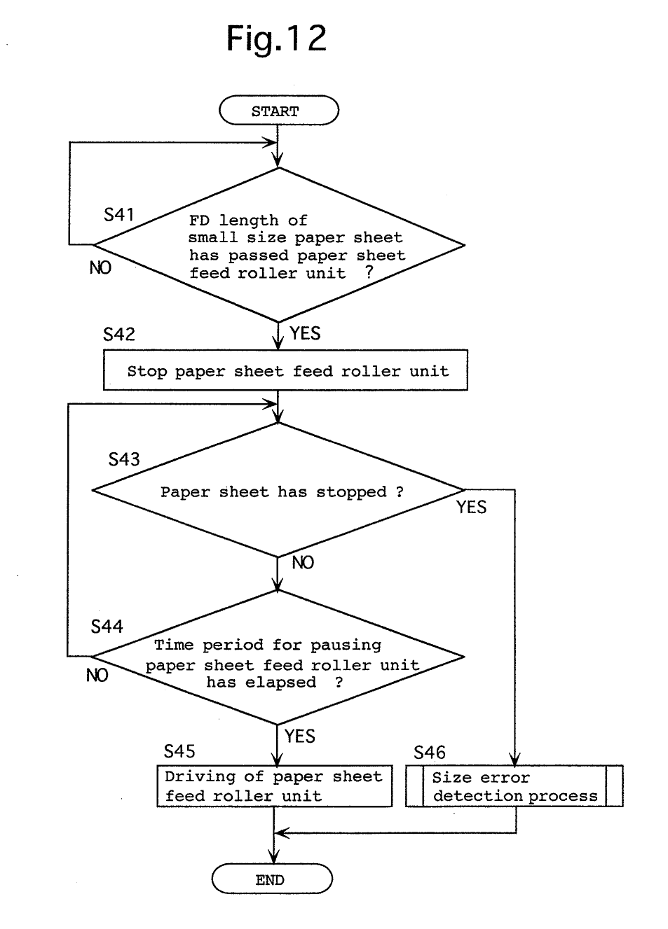

FIG. 12 shows an example of the operation of the size error judgment part 101 when a dynamic detector is used. As shown in FIG. 12, when the FD length of the small size recording paper sheet has passed the paper sheet feed roller unit 121, the paper sheet feed roller unit 121 is stopped; and when the sensor SE4 detects the stop of the recording paper sheet, a size error detection process is performed (steps S41 to S43, S46).

In addition, when the paper sheet feed roller unit 121 is started to be stopped, even if the sensor SE4 detects the movement of the paper sheet, the size error judgment part 101 judges that the length of the recording paper sheet is shorter than that of the normal size recording paper sheet upon detection of stop of the paper sheet before the predetermined pausing period elapses, and performs a size error detection process.

However, after the paper sheet feed roller unit is stopped, when the sensor SE4 detects the movement of the paper sheet for a predetermined pausing time, the size error judgment part 101 judges that the paper size is a desired size (normal size), and the driving of the paper sheet feed roller unit 121 is resumed (steps S43 to S45). It should be noted that a non-contact laser doppler speed meter and like dynamic detection sensors can be also employed as the dynamic detector.

In the size error judgment explained with reference to the flowcharts of FIGS. 6, 9, 10 and 12, the paper sheet feed roller unit 121 is paused for a predetermined time. However, the paper sheet feed roller unit 121 may not be completely stopped, but may be slowed down so that the paper sheets are transported at a speed lower than the speed of transport of the paper sheet during the normal driving.

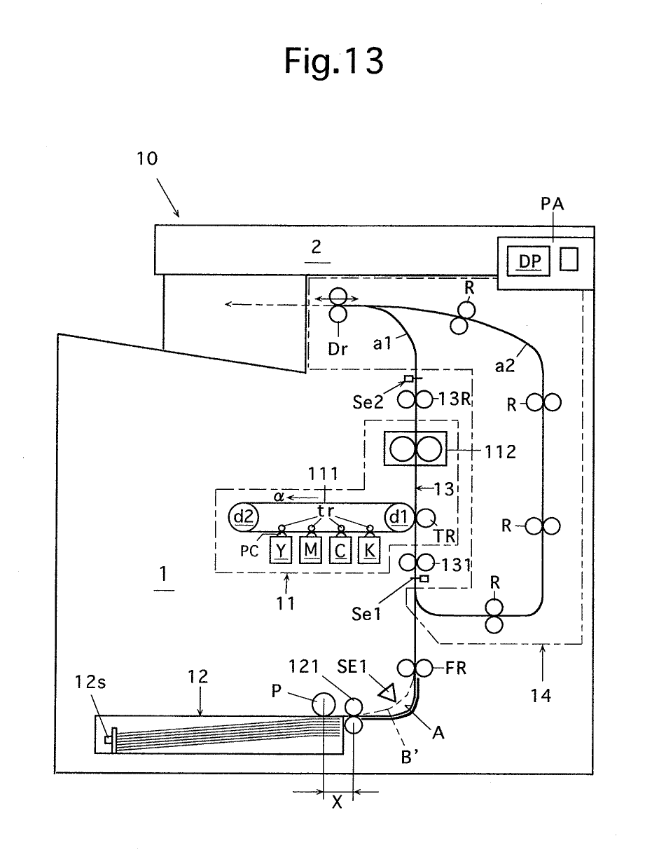

In addition, in the image forming device 10 in FIG. 1 described above, the transport roller unit on the stage next to the paper sheet feed roller unit 121 is the register roller unit 131. However, for example, as in the image forming device 10 shown in FIG. 13, a transport roller unit FR on the stage next to the paper sheet feed roller unit 121 may be employed. The roller unit FR may be positioned upstream of the register roller unit 131 but downstream of the paper sheet feed roller unit 121.

The image forming devices described above are a color image forming device of so-called tandem type, but the present invention can be also applied to color image forming devices of other types and also monochrome image forming devices. In addition, the present invention can be applied not only to image forming devices of the electrophotographying system, but also to image forming devices which print using inks.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming device which can feed a recording paper sheet of a normal size specified in a recording paper sheet size specifying part or detected by a recording paper sheet size detection part from a recording paper sheet feed part by a paper sheet feed roller unit to a transport roller unit on a next stage located downstream of the paper sheet feed roller unit in a direction of transport of the recording paper sheet; can form an image on the recording paper sheet by feeding the recording paper sheet from the transport roller unit to an image forming part; and have the paper sheet feed roller unit transport the recording paper sheet in feeding the recording paper sheet from the transport roller unit on the next stage to the image forming part,
the image forming device comprising a paper sheet transport path which leads the recording paper sheet from the paper sheet feed roller unit to the transport roller unit on the next stage;
a paper sheet detection sensor disposed downstream of the paper sheet feed roller unit in the direction of transport of the recording paper sheet but upstream of the transport roller unit, facing the paper sheet transport path, the paper sheet detection sensor being capable of detecting the recording paper sheet fed from the paper sheet feed roller unit; and
a size error judgment part which is for detecting a recording paper sheet size error when a small size recording paper sheet is mixed in the recording paper sheets of the normal size, the small size recording paper sheet being possibly expected to be mixed in the recording paper sheets of the normal size in the recording paper sheet feed part and having a length in the direction of transport of the recording paper sheet shorter than that of the normal size recording paper sheet,
the size error judgment part being so constituted that, in feeding a recording paper sheet from the recording paper sheet feed part, when the recording paper sheet is a recording paper sheet of the normal size and a time period from a point of time the normal size recording paper sheet is started to be fed by the paper sheet feed roller unit until a point of time a rear end of the normal size recording paper sheet completely passes the paper sheet detection sensor is T1, when the recording paper sheet is a small size recording paper sheet and a time period from a point of time the small size recording paper sheet is started to be fed by the paper sheet feed roller unit to a point of time a rear end of the small size recording paper sheet completely passes the paper sheet feed roller unit is T2, the size error judgment part temporarily slows down the paper sheet feed roller unit for a predetermined time period after the time T2 has elapsed from the time the recording paper sheet is started to be fed by the paper sheet feed roller unit but before the time T1 elapses; judges that there is a size error which means that a size of the recording paper sheet is not the normal size when the paper sheet detection sensor detects absence of the normal size recording paper sheet from the slowing down of the paper sheet feed roller unit for the predetermined time period; judges that there is no size error when the absence of the normal size recording paper sheet is not detected by the paper sheet detection sensor even if the paper sheet feed roller unit is slowed down for the predetermined time period and resumes a normal driving of the paper sheet feed roller unit after the predetermined time period has elapsed.

2. The image forming device according to claim 1, wherein the small size recording paper sheet has a length in the direction of transport of the recording paper sheet of 1/n (n is an integer) the length of the normal size recording paper sheet in the direction of transportation thereof.

3. The image forming device according to claim 1, wherein the paper sheet transport path comprises a long curved transport path along which the recording paper sheet passes when the recording paper sheet is transported to the transport roller unit on the next stage by continuous operation of the paper sheet feed roller unit, and when the paper sheet feed roller unit is slowed down in a state that the recording paper sheet lies across the paper sheet feed roller unit and the transport roller unit on the next stage and the transport roller unit on the next stage is in operation, the recording paper sheet on the long curved transport path can move onto a shorter curved transport path.

4. The image forming device according to claim 1, wherein a timing for starting slowing down of the paper sheet feed roller unit for the predetermined time period is a time point when the time T2 has elapsed from the start of feeding of the recording paper sheet by the paper sheet feed roller unit.

5. The image forming device according to claim 1, wherein the predetermined time period for slowing down the paper sheet feed roller unit is set to be shorter than a time period required for the normal size recording paper sheet moves onto a shortest paper transport path by transport of the recording paper sheet by the transport roller unit on the next stage from a state that the normal size recording paper sheet is located on the paper sheet transport path.

6. The image forming device according to claim 1, wherein the paper sheet detection sensor is a reflection type sensor which can detect the recording paper sheet by receiving light reflected from the recording paper sheet on the paper sheet transport path, and when there is a time period that the reflection type sensor cannot detect the recording paper sheet in the predetermined time period for slowing down the paper sheet feed roller unit, the size error judgment part judges that there is a size error.

7. The image forming device according to claim 1, wherein the paper sheet detection sensor comprises a transmission type sensor body and an actuator being capable of fitting to and retreating from the sensor body, and the paper sheet detection sensor is a transmission type sensor which can detect the recording paper sheet when the actuator is lifted by the recording paper sheet on the paper sheet transport path to retreat from the sensor body, and when there is a time period that the sensor cannot detect the recording paper sheet in the predetermined time period for slowing down the paper sheet feed roller unit, the size error judgment part judges that there is a size error.

8. The image forming device according to claim 1, wherein the paper sheet detection sensor is a distance sensor disposed in such a position that the sensor can detect a distance to the recording paper sheet on the paper sheet transport path, and the size error judgment part judges that there is a size error when the distance detected by the distance sensor is greater than a predetermined distance even after the predetermined time period for slowing down the paper sheet feed roller unit has elapsed.

9. The image forming device according to claim 1, wherein the paper sheet detection sensor is a dynamic detector which can detect movement of the recording paper sheet on the paper sheet transport path in a position in vicinity of the paper sheet feed roller unit, the size error judgment part stops the paper sheet feed roller unit during the predetermined time period for slowing down the paper sheet feed roller unit, and judges that there is a size error when there is a time period that the dynamic detector cannot detect the movement of the recording paper sheet while the paper sheet feed roller unit is stopped.

10. The image forming device according to claim 1, wherein the slowing down of the paper sheet feed roller unit is stopping of the paper sheet feed roller unit.
